(19) United States
(12) Patent Application Publication
(10) Pub. No.: US 2012/0250448 A1
(43) Pub. Date: Oct. 4, 2012

(54) DEVICE FOR MAKING MIXED DRINK

(76) Inventor: Wonchul Choi, Busan (KR)

(21) Appl. No.: 13/516,306

(22) PCT Filed: Jul. 1, 2011
(86) PCT No.: PCT/KR11/04825

§ 371 Date: Jun. 15, 2012

(30) Foreign Application Priority Data
Jul. 5, 2010 (KR) 10-2010-0064225

(51) Int. Cl. B01F 13/00

(52) U.S. Cl. 366/130

(57) ABSTRACT

Disclosed is a blended liquor maker, including: a cup having a receiving space defined therein, wherein the cup includes an opened top portion, a curved portion continuously bended along a side surface thereof, and at least one inclined-stepped annular portion formed on an inner peripheral surface thereof; and at least one separation plate having a circular flat plate shape, wherein, when received in the receiving space of the cup, the at least one separation plate is caught and fixed at an edge thereof on the stepped annular portion to divide the receiving space into upper and lower portions. In this case, the separation plate received inside the cup can be adjusted in height by pushing down the separation plate to bend the edge, thereby allowing users to suitably divide the receiving space of the cup. Accordingly, amounts of contents (e.g., spirits, beer, soju, beverages and the like) to be received in the cup can be properly adjusted to be suitable to the preference of users, thereby increasing the effectiveness of using thereof.

In addition, the cup can be made of a transparent resin material and the separation plate can be made of a pulp material, such that disposal products having a reduced unit cost can be produced and supplied to users, thereby providing easy access of users to ensure generality of using thereof.

### TECHNICAL FIELD

The present invention relates, in general, to a blended liquor maker, and more particularly to a blended liquor maker, in which a separation plate received inside a cup can be adjusted in height by pushing down the separation plate to bend an edge thereof so as to allow users to suitably divide a receiving space of the cup, such that amounts of contents (e.g., spirits, beer, soju (i.e., Korean distilled sprits), beverage and the like) to be received in the cup can be properly adjusted to be suitable to the preference of users, thereby increasing the effectiveness of using thereof.

### BACKGROUND ART

Recently, there are many changes in drinking cultures, and thus many persons drink a blended liquor which is made by blending spirits, beer, soju, beverages and the like. Such a blended liquor can cause persons, who drink the blended liquor, to get quickly drunk, and make a liquor having a high alcohol percent be soft, such that persons can drink the blended liquor depending on the drinking capacities or preferences of them. Therefore, drinkers or women who get easily drunk enjoy particularly drinking the blended liquor.

However, making the blended liquor in such an existing way is bothersome or inconvenience. In particular, when attempting to make a blended liquor while drinking spirits using a short glass, the short glass is put into a beer glass to blend the sprits with beer, and again the short glass is taken out of the beer glass, and then the resulted blended liquor is drunk. Therefore, liquor stuck on the outer surface of the short glass can drop down, and thus a table and the like are likely to be dirtied. In addition, there is a problem that a bottom surface and a portion, which is grasped by a hand, of the short glass placed on the table are got dirty and are unsanitary.

In order to solve the above problems, the present applicant proposed a blended liquor maker disclosed in Korean Patent No. 10-0908186. In this case, the blended liquor maker is put in a typical beer glass, and an alcoholic drink or a beverage can be injected in each of inner spaces of the glass which are divided by the blended liquor maker, thereby conveniently making the blended liquor. Also, it is not necessary to put a short glass into the beer glass and again take the shot glass out of the beer glass in order to make the blended liquor in a sanitary way.

However, for to blended liquor maker according to Korean Patent No. 10-0908186 proposed by the present invention, means for properly adjusting amounts of contents (e.g., spirits, beer, soju, beverages and the like) to be received in the bear glass depending on the preference of users is not included, thereby providing a somewhat low effectiveness in using thereof.

### DISCLOSURE

### Technical Problem

Accordingly, the present invention has been made keeping in mind the above problems occurring in the related art, and an object of the present invention is to provided to a blended liquor maker, in which a separation plate received inside a cup can be adjusted in height by pushing down the separation plate to bend an edge thereof so as to allow users to suitably divide a receiving space of the cup, such that amounts of contents (e.g., spirits, beer, soju, beverages and the like) to be received in the cup can be properly adjusted to be suitable to the preference of users, thereby increasing the effectiveness of using thereof.

Also, another object of the present invention is to provide a blended liquor maker, in which a cup can be made of a transparent resin material and a separation plate can be made of a pulp material, such that disposal products having a reduced unit cost can be produced and supplied to users, thereby providing easy access of users to ensure generality of using thereof.

### Technical Solution

In order to achieve the above objects, according to one aspect of the present invention, there is provided

a blended liquor maker including: a cup having a receiving spaces defined therein, wherein the cup includes an opened top portion, a curved portion continuously bended along a side surface thereof, and at least one inclined-stepped annular portion formed on an inner peripheral surface thereof; and at least one separation plate having a circular flat plate shape, wherein, when received in the receiving space of the cup, the at least one separation plate is caught and fixed at an edge thereof on the stepped annular portion to divide the receiving space into upper and lower portions; and wherein, when the separation plate is received in the cup, the curved portion forms a plurality of flow paths between the cup and the separation plate.

Also, at least one catching element may be further provided above the stepped annular portion formed on the inner peripheral surface of the cup, and the separation plate may be positioned between the stepped portion and the catching element, such that the catching element can prevent the separation plate from being slipped out, thereby securely fixing the separation plate.

Furthermore, the separation plate may include an annular bending groove formed on one side surface thereof, such that the edge thereof can be easily bended.

Furthermore, the edge of the separation plate may be provided with a plurality of notches arranged at constant intervals in a circumferential direction of the separation plate.

Also, a grip may be further formed to protrude from the center of the upper surface of the separation plate, thereby allowing users to easily grip the separation plate.

In addition, when including two or more separation plates, the separation plates may have a rectangular through hole respectively formed on the center of each thereof, and be connected to each other by a gripping element extending orthogonally through each of the rectangular through holes, wherein the gripping element may have a plurality of inserting grooves formed on opposing sides thereof and allowing inner surfaces of the through holes to be inserted therein.

### Advantageous Effects

For the blended liquor maker according to the present invention as described above, the separation plate received inside the cup can be adjusted in height by pushing down the separation plate to bend the edge, thereby allowing users to suitably divide the receiving space of the cup. Accordingly, amounts of contents (e.g., spirits, beer, soju, beverages and the like) to be received in the cup can be properly adjusted to be suitable to the preference of users, thereby increasing the effectiveness of using thereof.

In addition, the cup can be made of a transparent resin material and the separation plate can be made of a pulp material, such that disposal products having a reduced unit cost can be produced and supplied to users, thereby providing easy access of users to ensure generality of using thereof.

### DESCRIPTION OF DRAWINGS

FIG. 1 is a perspective view of a blended liquor maker according to an embodiment of the present invention;

FIG. 2 is an exploded perspective view of the blended liquor maker shown in FIG. 1;

FIG. 3 is a sectional view of the blended liquor maker taken along a line A-A shown in FIG. 1;

FIG. 4 is a plan view of the blended liquor maker shown in FIG. 1;

FIG. 5a is an exploded perspective view showing through holes formed in a plurality of separation plates and a griping element of a blended liquor maker according to another embodiment of the present invention;

FIG. 5b is a perspective view showing the griping portion coupled to the through holes formed in the plurality of separation plates of the blended liquor maker shown in FIG. 5a;

FIG. 6 is a view illustrating a method for adjusting a height of a separation plate of the blended liquor maker shown in FIG. 1; and

FIGS. 7a, 7b, and 7c are a view illustrating procedures of using the blended liquor maker shown in FIG. 1.

### BEST MODE

According to a best embodiment of a blended liquor maker according to the present invention, the blended liquor maker includes: a cup having a receiving space defined therein, wherein the cup includes an opened top portion, a curved portion continuously bended along a side surface thereof, and at least one inclined-stepped annular portion formed on an inner peripheral surface thereof; and at least one separation plate having a circular flat plate shape, wherein, when received in the receiving space of the cup, the at least one separation plate is caught and fixed at an edge thereof on the stepped annular portion to divide the receiving space into upper and lower portions. In this case, the separation plate received inside the cup can be adjusted in height by pushing down the separation plate to bend the edge, thereby allowing users to suitably divide the receiving space of the cup. Accordingly, amounts of contents (e.g., spirits, beer, soju, beverages and the like) to be received in the cup can be properly adjusted to be suitable to the preference of users, thereby increasing the effectiveness of using thereof.

Furthermore, the cup can be made of a transparent resin material and the separation plate can be made of a pulp material, such that disposal products having a reduced unit cost can be produced and supplied to users, thereby providing easy access of users to ensure generality of using thereof.

### DESCRIPTION OF EMBODIMENTS

A blended liquor maker according to exemplary embodiments of the present invention will now be described in detail with reference to the accompanying drawings.

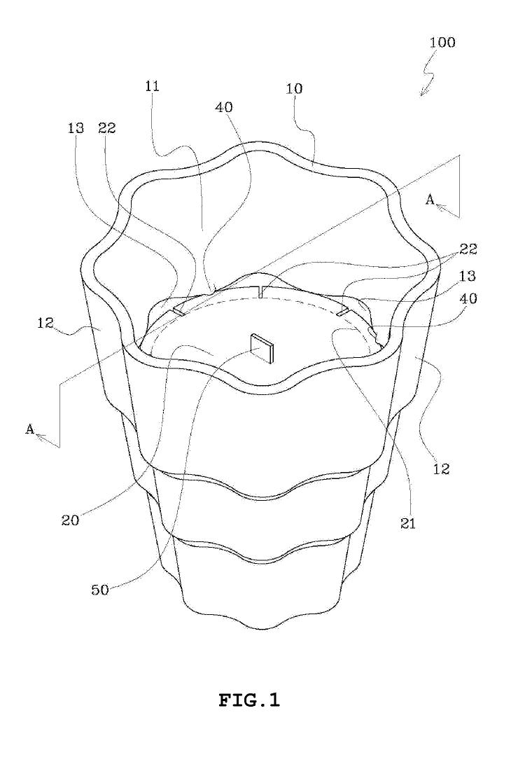

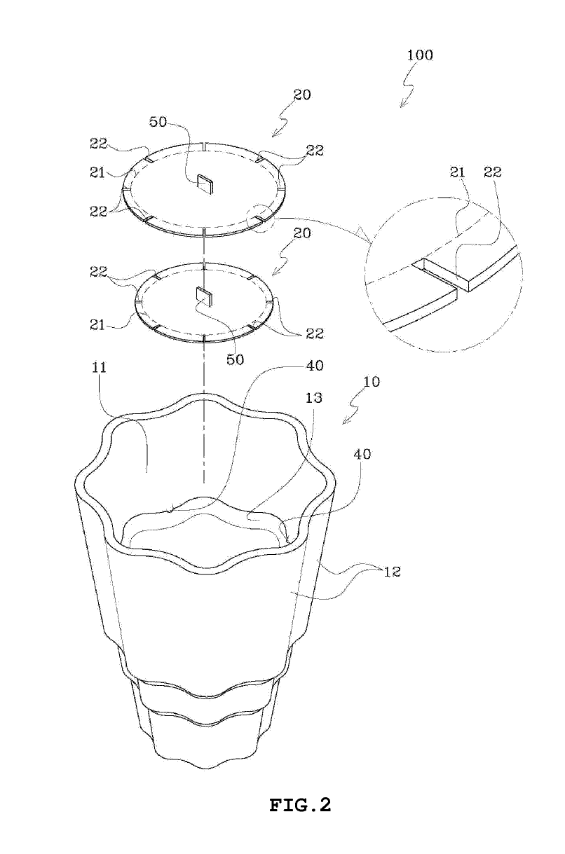

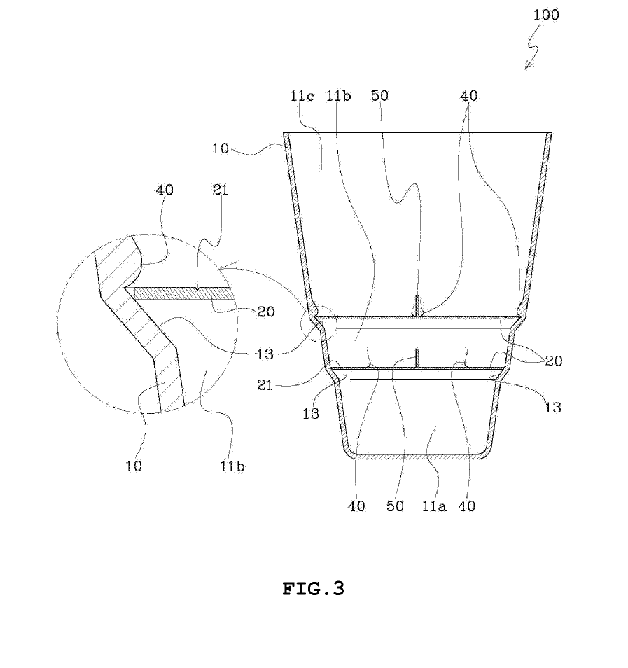

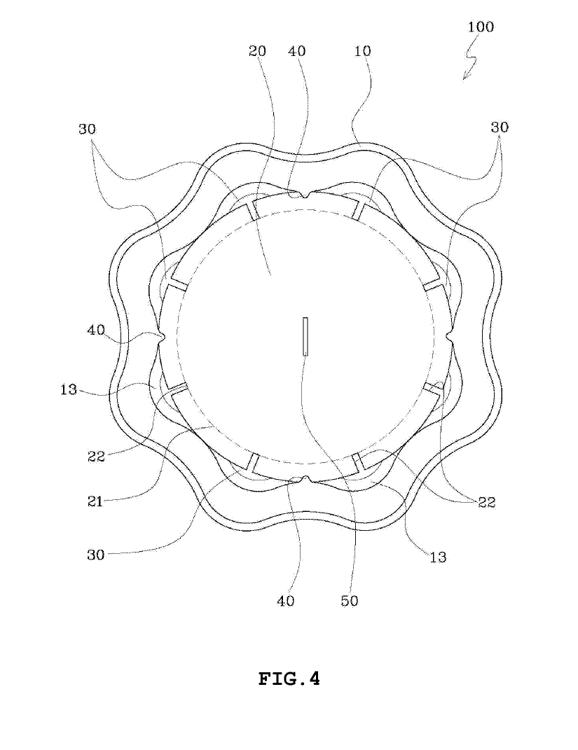

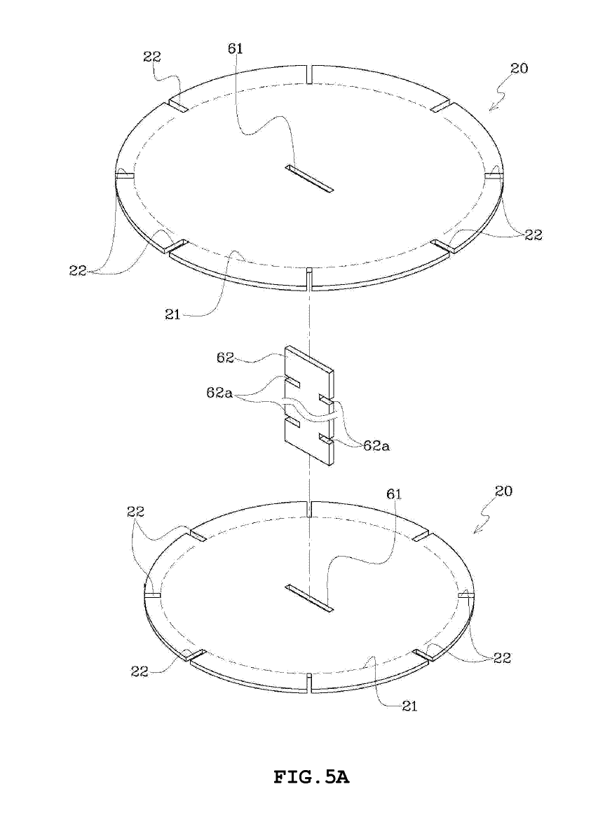

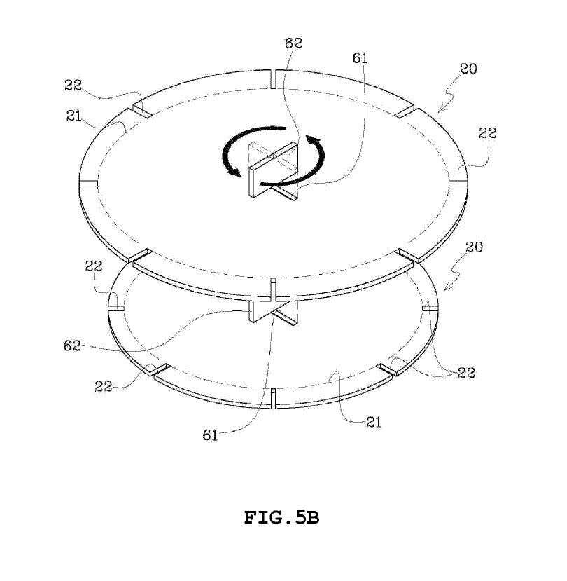

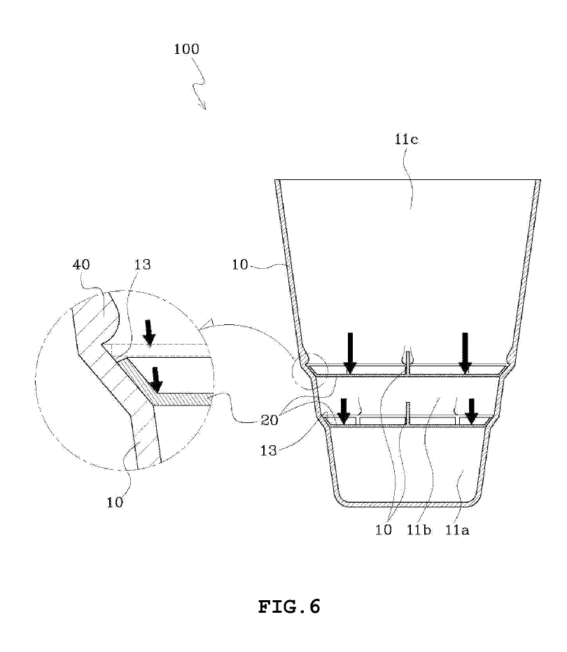

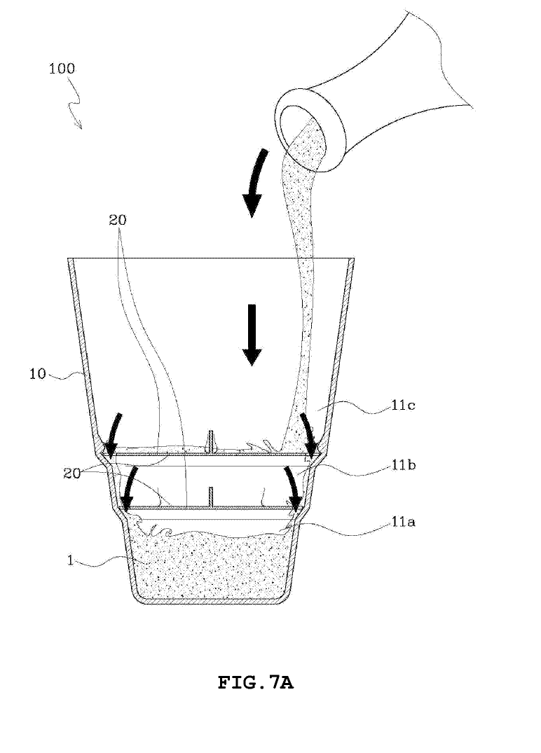

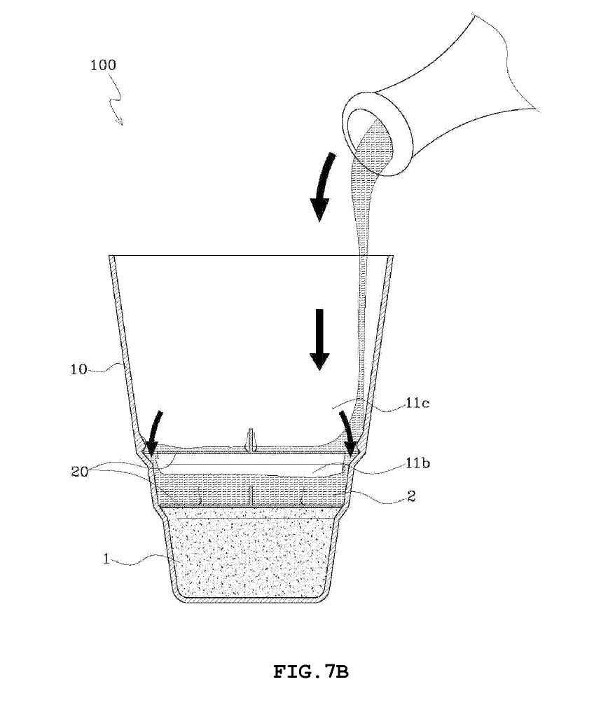

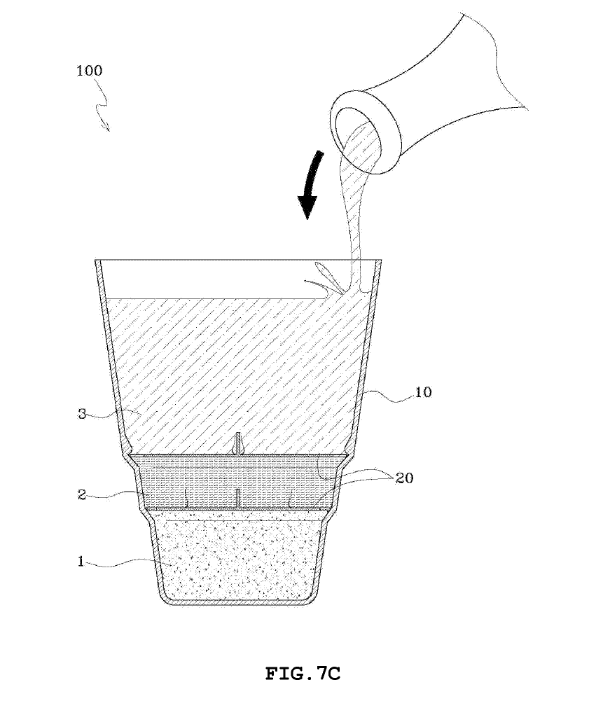

FIGS. 1 to 7c show a blended liquor maker according to embodiments of the present invention, in which FIG. 1 is a perspective view of a blended liquor maker according to an embodiment of the present invention; FIG. 2 is an exploded perspective view of the blended liquor maker shown in FIG. 1; FIG. 3 is a sectional view of the blended liquor maker taken along a line A-A shown in FIG. 1; FIG. 4 is a plan view of the blended liquor maker shown in FIG. 1; FIG. 5a is an exploded perspective view showing through holes formed in a plurality of separation plates and a griping portion of a blended liquor maker according to another embodiment of the present invention; FIG. 5b is a perspective view showing the griping portion coupled to the through holes formed in the plurality of separation plates of the blended liquor maker shown in FIG. 5a; FIG. 6 is a view illustrating a method for adjusting a height of a separation plate of the blended liquor maker shown in FIG. 1; and FIGS. 7a, 7b, and 7c are a view illustrating procedures of using the blended liquor maker shown in FIG. 1.

As shown in the drawings, a blended liquor maker 100 according to embodiments of the present invention includes a cup 10 and a separation plate 20.

As shown in FIGS. 1 to 4, the cup 10 has a receiving space 11 defined therein, and the cup 10 further includes an opened top portion, a curved portion 12 continuously bended along a side surface thereof, and at least one inclined-stepped annular portion 13 formed on an inner peripheral surface thereof.

In this case, the cup 10 is made of a transparent resin material and the separation plate 20 as described below is made of a pulp material, such that disposal products having a reduced unit cost can be produced and supplied to users, thereby providing easy access of users to ensure generality of using thereof.

The cup 10 of the blended liquor maker 100 according to the present invention includes two stepped annular portions 13, but the invention is not limited thereto.

As shown in FIGS. 1 to 4, there is provided at least one separation plate 20 which has a circular flat plate shape. When received in the receiving space 11 of the cup 10, the separation plate 20 is caught and fixed at an edge thereof on the stepped annular portion 13 to divide the receiving space 11 into upper and lower portions.

In this case, when the separation plate 20 is received inside the cup 10, contents (e.g., spirits, beer, soju, beverages and the like) can be easily introduced onto a bottom surface of the cup 10 through a plurality of flow paths 30 which are formed between the cup 10 and the separation plate 20 by the curved portion 12 as shown in FIG. 4.

The blended liquor maker 100 according to the embodiment of the present invention includes two separation plates 20 received in the cup 10, but the invention is not limited thereto. Specifically, because of having two separation plates 20, the receiving space 11 of the cup is divided into three sections as shown in FIG. 3, and the three sections divided as such are arbitrarily referred to as a lower section 11a, a middle section 11b and an upper section 11b sequentially from a section on the bottom surface of the cup 10 for convenience of explanation. Therefore, different contents (e.g., spirits, beer, soju, beverages and the like) are received in each of the three sections 11a, 11b, and 11c depending on the preference of users, thereby allowing a blended liquor desired by users to be made.

In particular, upon making a blended liquor, the blended liquor may be made by filling a sweet beverage 1 into the lower section 11a of the cup as shown in FIG. 7a, filling spirits (2) or soju, which has a relative high alcohol percent, into the middle section 11b as shown in FIG. 7b, and then putting a beer 3, which can be easily taken in, into the upper section 11c as shown in FIG. 7c. As a result, when users drink the resulted blended liquor, the first taste is a taste of the beer 3 which can be easily taken in, and the after taste is a taste of the sweet beverage 1, thereby thus allowing persons, who can't easily drink the spirits (2) or soju having a high alcohol percent, also to easily drink the blended liquor.

In addition, as shown in FIGS. 1 to 4, an annular bending groove 21 is formed on an upper surface of the separation plate 20 to easily bend the edge of the separation plate 20. Therefore, as shown in FIG. 6, the separation plate 20 received in the cup 10 can be adjusted in height by pushing down the separation plate 20 to bend the edge, thereby allowing users to divide the receiving space 11 of the cup 10 into suitable volumes. Accordingly, amounts of contents (e.g., spirits, beer, soju, beverages and the like) to be received in the cup 10 can be properly adjusted to be suitable to the preference of users, thereby increasing effectiveness of using thereof.

In this case, as shown in FIGS. 2 and 4, the edge of the separation plate 20 is preferably provided with a plurality of notches 22 arranged at constant intervals in a circumferential direction of the separation plate 20, such that the edge of the separation plate 20 can be further easily bended.

Also, as shown in FIG. 2, a grip 50 is preferably formed to protrude from the center of the upper surface of the separation plate 20 to allow users to grip the separation plate 20, thereby providing the convenience of using thereof to users.

In addition, as shown in FIGS. 1 to 4, one or more catching elements 40 are further provided above the stepped annular portion 13 formed on the inner peripheral surface of the cup 10 to position the separation plate 20 between the stepped annular portion 13 and the catching elements 40, such that the catching element 40 can prevent the separation plate 20 from being slipped out, thereby securely fixing the separation plate 20.

The blended liquor maker 100 according to the embodiment of the present invention includes four catching elements 40, but the invention is not limited thereto.

Furthermore, as shown in FIGS. 5a and 5b, when including two or more separation plates 20, the separation plates 20 may further have a rectangular through hole 61 formed on the center of each thereof, and be connected to each other by a gripping element 62 extending orthogonally through each of the rectangular through holes 61. The gripping element 62 may have a plurality of inserting grooves 62a formed on opposing sides thereof and allowing inner surfaces of the through holes 61 to be inserted therein.

Specifically, by coupling and fixing the plurality of separation plates 20 to the gripping element 62, the plurality of separation plates 20 can be disposed inside the cup 10 at a time, thereby providing the convenience of using thereof.

Hereafter, methods of assembling and using the blended liquor maker 100 according to the embodiments of the present invention having configurations as described above will be described in detail with reference to a structure of having two separation plates 20.

Firstly, as shown in FIG. 3, two separation plates 20 are inserted into the cup 10, and then edges of the separation plates 20 are disposed and fixed between the stepped annular portions 13 and the catching elements 40 formed inside the cup 10.

As described above, when the separation plates 20 are disposed and fixed inside the cup 10, the receiving space 11 of the cup 10 is divided into three sections (i.e., the lower section 11a, the middle section 11b, and the upper section 11c sequentially from a section on the bottom surface of the cup 10) because of two separation plates 20.

Then, as shown in FIGS. 7a, 7b, and 7c, users can make a desired blended liquor by filling different contents (e.g., spirits, beer, soju, beverages and the like) into each of three sections 11a, 11b and 11c depending on the preference of themselves.

In this time, as shown in FIG. 6, users can properly adjust a height of the separation plates 20 received in the cup 10 by pushing down the separation plates 20 to bend the edges, thereby dividing the receiving space 11 of the cup 10 into suitable volumes. Accordingly, amounts of contents (e.g., spirits, beer, soju, beverages and the like) to be received in the cup 10 can be properly adjusted to be suitable to the preference of users, thereby increasing effectiveness of using thereof.

Meanwhile, the blended liquor maker according to the present invention may also be used as a take-out cup for receiving a coffee, a tea and the like. Typical take-out cups have a lid coupled thereto, whereas the blended liquor maker according to the invention has the separation plate so as not to require an additional lid, and thus can be used for receiving an iced coffee or an iced tea containing ice cubes and the like. For example, one separation plate of the separation plates which is coupled to an upper end of the cup can have only a groove cut in a cross shape on the center thereof and be closed in any other portions.

Although the present invention has been disclosed with reference to the embodiments illustrated in the accompanying drawings, the disclosure is intended to illustrate, not to limit the invention. Accordingly, those skilled in the art will appreciate that various alternative and equivalent embodiments can be made based on the disclosure. In addition, those skilled in the art can make various modifications and variations of the invention without departing from the scope and spirit of the invention. Therefore, the claimed scope of the present invention is not limited to the scope of the detailed description, but should be defined by following claims and their technical sprit.

### INDUSTRIAL APPLICABILITY

The present invention can be widely applied to the fields of designing and manufacturing a blended liquor maker.

What is claimed is:

1. A blended liquor maker comprising:
a cup (10) having a receiving space (11) defined therein, wherein the cup (10) includes an opened top portion, at least one curved portion (12) formed on an inner peripheral surface thereof, and at least one stepped portion (13) formed on the inner peripheral surface including the curved portion (12).

2. The blended liquor maker according to claim 1, further comprising at least one separation plate (20), wherein, when received in the cup (10), the separation plate (20) has an edge contacted with the stepped portion (13) and at least one flow path (30) is formed between the curved portion (12) and the separation plate (20).

3. The blended liquor maker according to claim 2, wherein at least one catching element (40) is provided above the stepped portion (13) of the cup (10), and the edge of the separation plate (20) is positioned between the stepped portion (13) and the catching element (40).

4. The blended liquor maker according to claim 2, wherein the separation plate (20) comprises a bending groove (21) formed on one side surface thereof.

5. The blended liquor maker according to claim 4, wherein the separation plate (20) comprises at least one notch (22) formed on the edge thereof.

6. The blended liquor maker according to claim 2, wherein the separation plate (20) comprises a grip (50) provided on one side surface thereof.

7. A blended liquor maker for making a blended liquor comprising a cup and a separation plate received in the cup, the separation plate comprising a annular bending groove (21) formed on edge of one side surface thereof, at least one notch (22) having an end formed toward the bending groove (21), and a grip (50) provided on the one side surface.

8. The blended liquor maker according to claim 7, wherein when including two or more separation plates (20), each of the separation plates (20) have a rectangular through hole (61) formed on the center thereof, and wherein the blended liquor maker further comprises a gripping element (62) having a plurality of inserting grooves (62a) and configured to be inserted in the through hole (61) of each of the separation plates (20).
